(19) United States
(12) Patent Application Publication
(10) Pub. No.: US 2009/0158139 A1
(43) Pub. Date: Jun. 18, 2009

(54) Methods And Systems For Generating A Markup-Language-Based Resource From A Media Spreadsheet

(76) Inventors: Robert P. Morris, Raleigh, NC (US); David B. Lection, Raleigh, NC (US)

Correspondence Address: SCENERA RESEARCH, LLC, 111 CORNING RD., SUITE 220, CARY, NC, 27518, US

(21) Appl. No.: 11/958,701

(22) Filed: Dec. 18, 2007

(51) Int. Cl. G06F 17/20

(52) U.S. Cl. 715/234

(57) ABSTRACT

Methods and systems are described for generating a markup-language-based resource from an electronic media spreadsheet. An exemplary method includes receiving first and second cell information for first and second cells of an electronic media spreadsheet to produce as first and second cell outputs first and second media streams, respectively, via the electronic media spreadsheet, where the second cell information includes an expression dependent on the first cell output for producing the second media stream. The method also includes generating a markup-language-based resource having first and second markup language representations of the first and second cells, respectively, and generating directions compatible with the markup-language-based resource representing the expression of the second cell. The generated directions are configured for processing by a web browser with the markup language-based resource to produce a presentable representation of the second media stream via the web browser.

### BACKGROUND

Typically, markup-language-based resources, such as web pages, exported from spreadsheets are static in nature. That is, web pages exported from spreadsheets usually include text, numbers, and perhaps fixed images, and generally do not include dynamic content, such as steaming media objects. Creating media rich web pages that integrate dynamic content generally requires expensive tools, as well as training and skills not typically possessed by ordinary computer users. Some tools provide a WYSIWYG user interface for constructing complex page structures using tables. Nevertheless, these tools still require a great deal of manual data entry, knowledge of HTML and knowledge of a scripting language such as JavaScript.

Accordingly, there exists a need for methods, systems, and computer program products for generating a markup-language-based resource that exhibits dynamic content.

### SUMMARY

Methods and systems are described for generating a markup-language-based resource from an electronic media spreadsheet. An exemplary method includes receiving first and second cell information for first and second cells of an electronic media spreadsheet to produce as first and second cell outputs first and second media streams, respectively, via the electronic media spreadsheet, where the second cell information includes an expression dependent on the first cell output for producing the second media stream. The method also includes generating a markup-language-based resource having first and second markup language representations of the first and second cells, respectively, and generating directions compatible with the markup-language-based resource representing the expression of the second cell. The generated directions are configured for processing by a web browser with the markup language-based resource to produce a presentable representation of the second media stream via the web browser.

According to another aspect a system for generating a markup-language-based resource from an electronic media spreadsheet is disclosed. The system includes a cell access manager component configured for receiving first and second cell information for first and second cells of an electronic media spreadsheet to produce as first and second cell outputs first and second media streams, respectively, via the electronic media spreadsheet, wherein the second cell information includes an expression dependent on the first cell output for producing the second media stream, and an export translator component configured for generating a markup-language-based resource having first and second markup language representations of the first and second cells, respectively, and for generating directions compatible with the markup-language-based resource representing the expression of the second cell. The generated directions are configured for processing by a web browser with the markup language-based resource to produce a presentable representation of the second media stream via the web browser.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for generating a markup-language-based resource from an electronic media spreadsheet according to an embodiment;

FIG. 2 is a block diagram illustrating a system for generating a markup-language-based resource from an electronic media spreadsheet according to one embodiment;

FIG. 2A is a block diagram illustrating a detailed view of a component of the system shown in FIG. 2 according to an exemplary embodiment;

FIG. 3 is a block diagram illustrating a system for generating a markup-language-based resource from an electronic media spreadsheet according to another embodiment;

FIG. 4 is a block diagram illustrating a system for generating a markup-language-based resource from an electronic media spreadsheet according to another embodiment; and

FIG. 5 illustrates a user interface for generating a media stream in a media spreadsheet according to one embodiment.

### DETAILED DESCRIPTION

Methods and systems are described for generating a markup-language-based resource from an electronic media spreadsheet. According to one embodiment, graphically rich presentations can be created in a media spreadsheet, as described in a co-pending U.S. patent application Ser. No. 11/680,403 entitled, “Methods and Systems for Generating a Media Stream in a Media Spreadsheet,” filed on Feb. 28, 2007, commonly owned with the present application, and incorporated here by reference in its entirety. There, a first cell of a plurality of cells of an electronic spreadsheet is associated with a source media stream object, and a transformation operation is associated with the first cell or another cell, where the transformation operation references, in an embodiment, the source media stream object or the first cell, respectively. When the transformation operation is applied to the source media stream object, a resultant media stream object is generated. The resultant media stream object is then associated with at least one of the plurality of cells of the electronic spreadsheet. Accordingly, when the media spreadsheet is presented, streaming media objects, e.g., video and audio streams, can be presented in one or more cells of the electronic media spreadsheet.

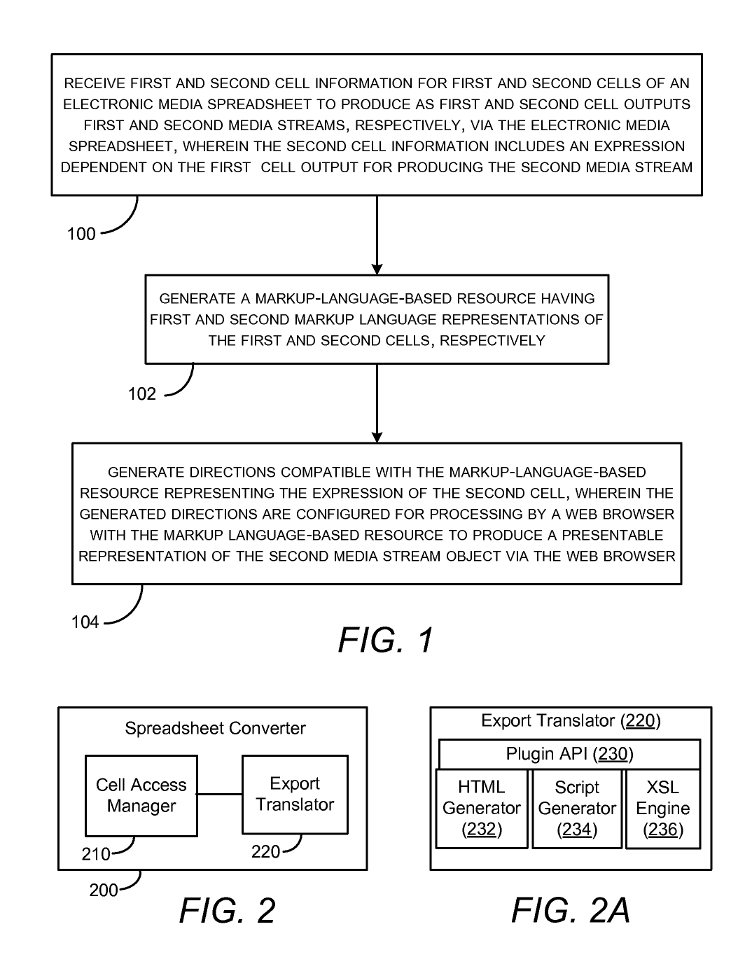

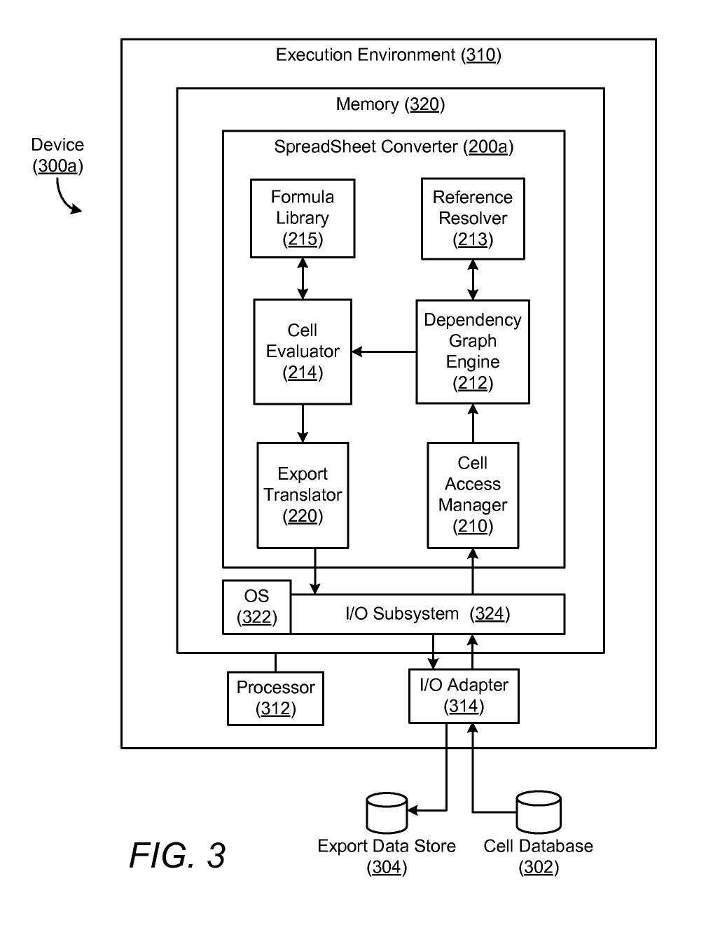

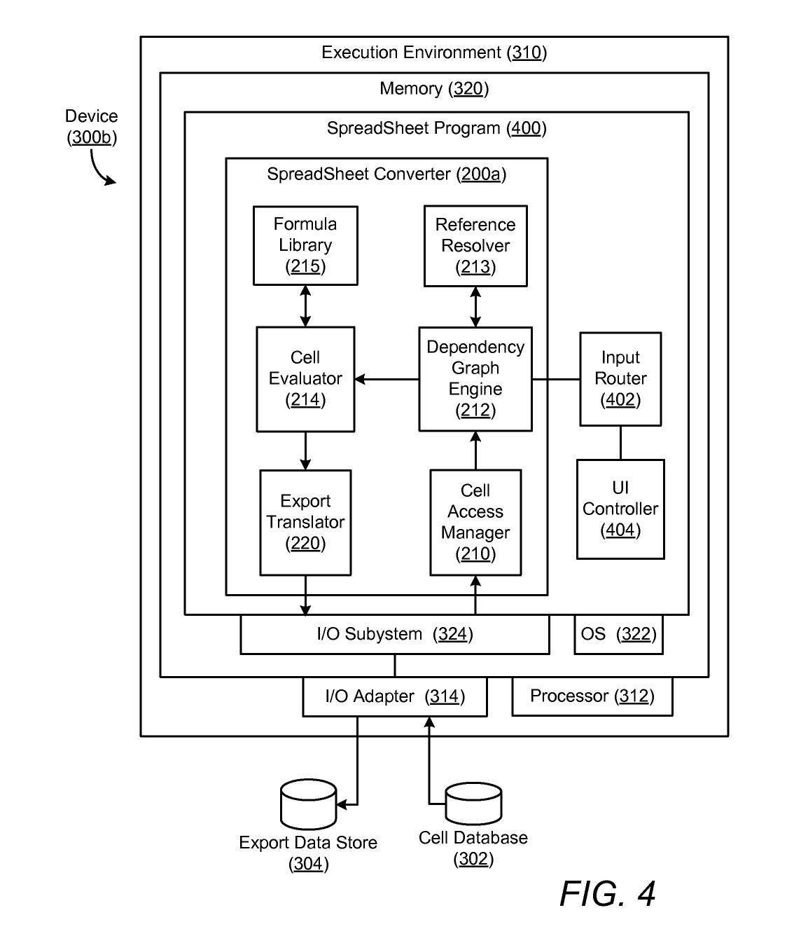

According to the subject matter described herein, an electronic media spreadsheet can be transformed into a markup-language-based resource, such as a web page, so that dynamic content of the spreadsheet can be presented in a standard web browser. FIG. 1 is a flow diagram illustrating a method for generating a markup-language-based resource from an electronic media spreadsheet comprising a plurality of cells according to an exemplary embodiment. FIG. 2, FIG. 3 and FIG. 4 are block diagrams illustrating systems for generating a markup-language-based resource from an electronic media spreadsheet according to several exemplary embodiments. In particular, FIG. 2 is an exemplary spreadsheet converter component 200 that is configured for generating a markup-language-based resource from an electronic media spreadsheet, while FIG. 3 and FIG. 4 illustrate another embodiment of the spreadsheet converter component 200a implemented, respectively, in a client device 300a, and in a spreadsheet program 400 in a client device 300b. The method illustrated in FIG. 1 can be carried out by, for example, some or all of the components illustrated in the exemplary systems of FIGS. 2, 3 and 4.

Illustrated in FIG. 2 is a spreadsheet converter component 200 that is configured to operate within an execution environment of a device. The spreadsheet converter component 200 can operate within a wide range of execution environments and devices. For example, the spreadsheet converter component 200 can operate in an execution environment including hardware, such as a processor, for processing instructions included in the spreadsheet converter component 200, a processor memory for storing at least a portion of the spreadsheet converter component 200 allowing the processor to access instructions and data included in the system.

Illustrated in FIG. 3 and in FIG. 4 are client devices 300a, 300b that include an exemplary execution environment 310 for supporting and hosting a spreadsheet converter 200a and spreadsheet program 400, respectively. The exemplary execution environment 310 includes a persistent storage (not shown) such as a hard drive, which can be used for storing a cell database 302 and an export data store 304. The exemplary execution environment 310 can also include an input output (I/O) adapter 314 operatively coupled to the persistent storage and configured to interoperate with an I/O subsystem 324 included in the execution environment 310 for reading to, writing from, and otherwise managing the persistent storage and associated stored data. The execution environment 310 includes a processor memory 320 for storing at least a portion of instructions and data associated with executable entities such as the spreadsheet converter 200a and the spreadsheet program 400. Data stored in the processor memory 320 is accessible to a processor 312 for processing.

Management of resources of the execution environment 310 such as the processor memory 320 and the persistent storage is provided for by an operating system 322 interoperating with various subsystems known to those in the art such as a memory management system (not shown), a loader (not shown), a linker (not shown), and the I/O subsystem 324 including the I/O adapter 314. The resources and subsystems provided by an execution environment 310 depend on the needs of the spreadsheet converter 200a, the spreadsheet program 400, and other requirements associated with the device 300a, 300b hosting the execution environment 310. For example, some devices 300a, 300b can include an execution environment that provides a network subsystem providing for sending and receiving data over a network.

The spreadsheet converter 200a and the spreadsheet program 400 can be configured to be hosted and processed by the same execution environment 310 and/or by different execution environments according to their various embodiments. Thus, both the converter 200a and the program 400 can operate, for example, on PCs, laptops, and handheld devices of various types, including mobile phones and PDAs. Similar numbers are used in FIG. 2, FIG. 3 and FIG. 4 to denote similar function, not equality, in the implementation of the various components.

Referring to FIG. 1, in block 100 first and second cell information is received for first and second cells of an electronic media spreadsheet to produce, as first and second cell outputs, first and second media streams, respectively, via the electronic media spreadsheet. The second cell information includes an expression dependent on the first cell output for producing the second media stream. Accordingly, a system for generating a markup-language-based resource from an electronic media spreadsheet includes means for receiving the first and second cell information for first and second cells of an electronic media spreadsheet to produce as first and second cell outputs, first and second media streams, respectively, via the electronic media spreadsheet, wherein the second cell information includes an expression dependent on the first cell output for producing the second media stream. For example, as illustrated in FIG. 2, a cell access manager component 210 in the spreadsheet converter component 200 is configured for receiving first and second cell information for first and second cells of an electronic media spreadsheet to produce, as first and second cell outputs, first and second media streams, respectively, via the electronic media spreadsheet, wherein the second cell information includes an expression dependent on the first cell output for producing the second media stream.

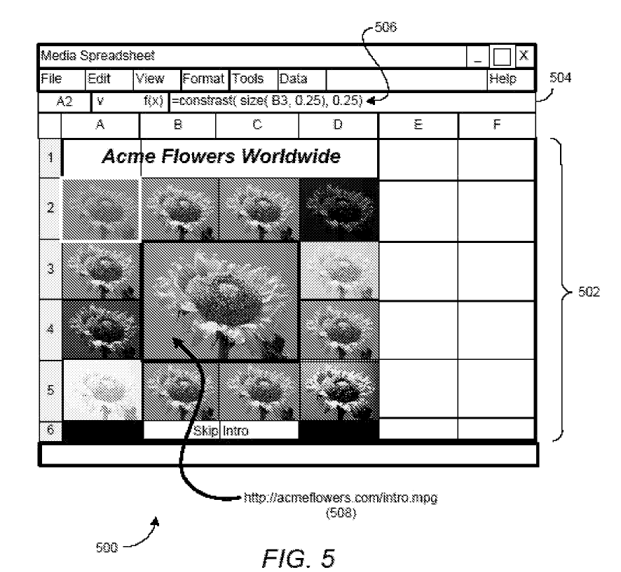

According to one embodiment, the cell access manager component 210 is configured to receive input formatted in a spreadsheet compatible format. For example, in the systems shown in FIG. 3 and FIG. 4, the cell access manager component 210 is configured to receive spreadsheet data from a cell database 302 providing persistent storage. FIG. 5 illustrates an exemplary window 500 presented, for example, by the spreadsheet program 400 in the client device 300b depicted in FIG. 4. The cell database 302, in the example, is configured to receive an expression 506, “=contrast( size(B3, 0.25), 0.25)”, displayed in a cell content editor widget 504 of the spreadsheet window 500. The expression 506 is included in an association with a cell, e.g., A2, in a spreadsheet 502 as indicated by the highlighting of the cell A2 in FIG. 5.

According to one embodiment, the expression 506 can include at least one function or operator for operating on data that can be directly associated with the cell, e.g., by typing the data into the cell using a keyboard. The data can also be associated with the cell using a reference, and/or generated using a portion of the expression, for example, in the case of a nested expression. The expression 506 specifies, in an embodiment, a calculation and/or operation for generating a result or value for associating with the cell as output.

Returning to the cell A2, the expression 506 includes a reference to another cell, e.g. B3, of the spreadsheet 502. The referenced cell B3 is the result of the merging of four cells, e.g., B3, B4, C3, and C4. The referenced cell, B3, in this example, is associated with a reference 508, “http://acmeflowers.com/intro.mpg,” enabling access to an external resource that is a media stream object, specifically, an MPEG media stream. In the example, a representation of the spreadsheet 502 is stored in the cell database 302 by the spreadsheet program 400 in a spreadsheet format compatible with the spreadsheet program 400.

Analogously, the cell database 302 is configured to store the remaining cells of the spreadsheet 502. For instance, cell A1 is associated with the content, “Acme Flowers Worldwide,” of type “text.” Cell A1 is a merged cell created from the merging of cells A1-D1. Cells A6 and D6 are cells of type text with empty content and display attributes such as background color. Alternatively, they could be treated as cells with no content with a display attribute in an alternate embodiment. Cell B6 is a merged cell created from a merging of cells B6 and C6. In an embodiment, cell B6 is associated with an expression supporting linkable media objects. Cell B6, for example, can be associated with an expression, “=link(“file://c/icons/skip.jpg”), “image/jpeg”, “Home!A1:D6)”. The link expression when evaluated produces a visual representation of a resource identified in the first parameter field. The type of the resource in the first parameter field is identified in the second parameter field, and the third parameter field is interpreted as a link to be followed by the spreadsheet when an input is received associated with the cell B6 indicating the link should be activated.

Cells B2:D2, D3:D5, A3:A5, and B5:C5, in the example, are associated with expressions referencing a media stream object in a manner similar to cell A2 previously described. Each cell directly references B3, as A2 does, or indirectly references B3 by referencing a cell such as A2 that is associated with the expression 506 that produces a result based on a reference to B3. Thus, in the example, the output of each of these cells is based on the content of B3 that is located by the reference 508. The window 500 depicted in FIG. 5 is representative of a spreadsheet user interface and not intended to be an exhaustive representation of all spreadsheet user interface metaphors, but rather a representative interface that demonstrates the functions unique to the media spreadsheet.

In some embodiments, only cells of a spreadsheet 502 associated with content are stored in the cell database 302. In other embodiments, storage is allocated in the cell database 302 for all cells in a specified region or regions of a spreadsheet 502 including empty cells within the region or regions. Embodiments of the spreadsheet converter 200, 200a and embodiments of the spreadsheet program 400 can be configured to support multi-sheet spreadsheets, multi-spreadsheet evaluation including distributed spreadsheets, shared spreadsheets, and sheets supporting more than two dimensions although presentation of spreadsheets supporting more than three dimensions becomes increasingly difficult as the number of dimensions supported increases.

In receiving the cell information of the electronic media spreadsheet 502 from the cell database 302, the cell access manager 210 of the spreadsheet converter 200, 200a is configured to receive first and second cell information for first and second cells of the electronic media spreadsheet 502, where the second cell information includes an expression 506 dependent on the first cell output for producing the second media stream. In this example, the second cell is cell A2 and the expression 506 is dependent on the output of the first cell, which is cell B3. Cell B3, as previously indicated, is associated with a first media stream by the external reference 508. The cell access manager component 210 invokes, in one embodiment, a file system (not shown) provided by the OS 322 to read, and thus receive, cell information from the cell database 302. The file system interoperates with the I/O subsystem 324 that provides a common interface for communicating with I/O adapters 314 of various types to read, write, and manage the persistent storage and stored data.

In other embodiments, the cell access manager component 210 can be configured to receive cell information from a remote source by interoperating with a network subsystem operatively coupled to a network. Alternatively or additionally, the cell access manager component 210 can be configured to receive cell information by interoperating with an input subsystem (not shown) configured to receive input from one or more input means as controlled by a user. For example, the spreadsheet program 400 can include an input router 402 configured to receive input data via an input controller 404 from an input device such as a mouse, keyboard, and four-way controller as supported by the execution environment 310. In other embodiments, the cell access manager component 210 can be configured to receive cell information from other spreadsheet converters, spreadsheet programs, and/or other executables by being configured to use event subsystems, queues, pipes, and other means supported by a particular execution environment 310 (not shown in FIG. 3 or FIG. 4), and apparent to those skilled in the art given the description provided in this document.

Returning to FIG. 1, in block 102 a markup-language-based resource having first and second markup language representations of the first and second cells, respectively, is generated. Accordingly, a system for generating a markup-language-based resource from an electronic media spreadsheet includes means for generating a markup-language-based resource having first and second markup language representations of the first and second cells, respectively. For example, as illustrated in FIG. 2, an export translator component 220 is configured for generating a markup-language-based resource having first and second markup language representations of the first and second cells, respectively.

According to one embodiment, the spreadsheet converter 200, 200a is configured to analyze the dynamic behavior of the media spreadsheet as well as its presentation attributes in order to generate a markup-language-based resource that, when presented, provides a similar appearance and behavior of the electronic media spreadsheet. For example, the spreadsheet converter 200a shown in FIG. 3 and FIG. 4 includes a dependency graph engine 212 that is configured to detect and/or generate a dependency graph based on cell information received by the cell access manager 210. In some embodiments, the cell database 302 can store a spreadsheet, e.g., 502, in a dependency graph format requiring the dependency graph engine 212 to construct the dependency graph as the cell access manager 210 provides cell information. In other embodiments, the dependency graph engine 212 can generate and store in the processor memory 320 and/or persistent storage a dependency graph representation separate from the cell information received by the cell access manager 210.

In one embodiment, the dependency graph is generated based on the cells that have associated content. Each cell with associated content is represented by a corresponding node in the dependency graph, and each reference in the content associated with a cell is represented by an arc in the dependency graph that corresponds to a dependency relationship.

For example, in the spreadsheet 502 shown in FIG. 5, cell A1 is associated with content and thus has a corresponding node in the corresponding dependency graph, but because the content associated with cell A1 does not include a reference, the corresponding node has no associated dependency arcs. This information indicates to the spreadsheet converter 200a that the evaluation of cell A1 has no dependencies on the evaluation of any other cells in the spreadsheet 502. That is, A1's behavior is independent from the behavior of the other cells in the spreadsheet 502.

Cell A2 and cell B3 are associated with content as previously discussed. Thus, each is associated with a corresponding node in the dependency graph. Cell B3's content includes an external reference 508 to a resource. In an embodiment, a reference resolver component 213 is provided for resolving the external reference 508. The dependency graph can provide a node for representing the external resource and a dependency arc from B3's node and the node corresponding to the external resource. In some embodiments, this information is implicit so no node is created corresponding to the external resource and the associated dependency arc is not represented explicitly either.

Cell A2's content includes the expression referring to cell B3. Accordingly, an arc is represented from the node of A2 to the node of B3 indicating that the evaluation of cell A2 depends on the evaluation of cell B3, thus the evaluation of cell B3 must be performed first. Any exported representation of the spreadsheet 502 must account for the behavior in an associated visual representation caused by this dependency of cell A2 on the output of cell B3. Accordingly, the dependency graph identifies an order of evaluation between cell A2 and cell B3 of the electronic media spreadsheet 502.

In an embodiment, the dependency graph engine 212 can direct the order of export of the spreadsheet to a markup-language-based resource based on the dependency graph. For example, the dependency graph engine 212 can be configured to make at least one pass of the spreadsheet for generating the markup-language-based resource. In a first pass, the dependency graph engine 212 can use structural information associated with the cells of the spreadsheet 502 to generate the markup-language-based resource including a structural representation of the cells in the spreadsheet 502. This first pass can include empty cells when empty cells have an affect on the visual presentation of the spreadsheet 502.

During the first pass, the dependency graph engine 212 can, in one embodiment, provide cell information to a cell evaluator 214 indicating cell evaluation is for export. In one embodiment, the cell evaluator 214 can be configured to convert the provided cell information to a standard format from which all exported formats can be generated. Providing a standard internal format allows generators and/or translators for new exported formats to be implemented easily. In some embodiments, the standard format can be used for storing the cell information in the cell database 302 so that conversion to the standard format is unnecessary. Alternatively, the dependency graph engine 226 can be configured to use the standard format to create the dependency graph thereby eliminating the need for conversion.

The standard format can include identifiers for functions and/or operators included in expressions 506. Mapping of functions and/or operators, in an embodiment, is performed using a formula library 215. In one embodiment, the formula library 215 can be configured to map function names and/or operators to a common name space. Additionally or alternatively, the formula library 215 can be configured to provide access to instructions for performing the expression 506 associated with the cell. The formula library 215 will be discussed in more detail below.

According to an exemplary embodiment, when the dependency graph engine 212 is ready to begin directing the export processing, the dependency graph engine 212 invokes an export translator component 220 that is configured to export cell information received from the cell evaluator 214 and/or the dependency graph engine 212. In the first pass in exporting the spreadsheet 502, for example, the export translator component 220 is configured to generate a markup-language-based resource based on a markup language identified for the resource. The first pass produces a resource that supports the structure and much of the appearance of the spreadsheet 502, particularly its static appearance attributes.

Typically, spreadsheets are stored in an XML based markup language. Converting an XML markup language to another markup language, such as XHTML, or not, e.g., PDF, or to a resource file for a use in an execution environment, such as a Java or a Windows resource file, can be performed using a extensible Stylesheet Language Transformation (XSLT) specification defined for translating from a particular XML language, such as the spreadsheet language or the standard format, to a second particular format. The second format can be a markup language based format as is known to those skilled in the art and reflected in current spreadsheet export capabilities.

FIG. 2A is a block diagram of an exemplary export translator component 220 according to one embodiment. As shown, the export translator component 220 can include a plugin API 230 allowing the export translator component 220 to support a variety of export formats. For example, the plugin API 230 can support an HTML generator 232 configured to translate a representation of the spreadsheet 502 to an HTML resource. In addition, the plugin API 230 can support a script generator 234 configured to generate scripts, e.g., JavaScript, for associating with a markup-language-based resource, e.g., the HTML resource generated by the HTML generator 232. Moreover, an Extensible Stylesheet Language (XSL) engine 236 can be supported and configured to, in one embodiment, for transforming spreadsheets 502 based on XSLT specifications to a variety of resource formats. The XSL engine 236 can be configured with an XSLT document configured to translate the spreadsheet 502 to a document format including a markup-language-based resource including one or more scripts. New and/or different formats can be supported by the plugin API 230.

Examples 1 and 2 below provide portions of a first pass markup-language-based resource generated by the export translator 220 based on the electronic media spreadsheet 502. In each example, the spreadsheet converter 200a is configured to generate a markup-language-based resource compatible with a target application, e.g., a web browser. A configuration can be hard-coded, configured through a configuration file, and/or received via a user interface, for example. Given the target application, the export translator component 220 can be configured to use any combination of markup languages supported by the target application.

In Example 1, the export translator 220 is specifically configured to generate markup language that can include a combination of HTML and Simplified Multimedia Integration Language (SMIL) as supported by the web browser. Based on the configuration, the export translator 220 generates an initial HTML element and header section depicted in Example 1 in template form.

### EXAMPLE 1

<html xmlns:time=“urn:schemas-microsoftie-com:time”
xmlns=“http://www.w3.org/TR/REC-html40”>
<head>
<meta http-equiv=Content-Type content=“text/html;
charset=windows-1252”>
<?import namespace=“time” implementation=“#default#time2”>
<style>.time {behavior: url(#default#time2)}</style>
<style id=“AcmeFlowers_12345_Styles”>
<!--table
-->
</style>
</head>

The initial <html> element defines the xml names spaces used in the generated output. The HTML 4.0 namespace and a “time” namespace defined in a MICROSOFT schema for supporting SMIL are specified. The <header> includes meta-information, imports the “time” namespace and defines a number of styles to be used in elements to provide a similar look and feel to the HTML/SMIL markup-language-based document that the spreadsheet 502 has in the presentation by the spreadsheet program 400, as depicted in FIG. 5. The styles are not listed for brevity's sake.

In some embodiments, the dependency graph engine 212 can process all the cell information identifying all header information including style information for markup elements associated with each cell prior to directing export of any information. For example, a style is generated by the export translator 220 including a specification for a black background for markup elements generated for cell A6 and D6.

The generated first pass resource can be constructed in one pass in an embodiment. In other embodiments, the export translator 220 is configured to create a document object module (DOM) corresponding to the generated markup-language-based resource. Interoperating with a DOM allows the export translator 220 to add, remove, and/or update portions of the generated first pass resource when each cell is processed by the export translator 220 adding, removing, and/or updating data where needed in the resource based on the cell information received by the export translator 220.

Example 2 below illustrates the remainder of the first pass markup-language-based resource generated based on structural relationships among the cells of the electronic media spreadsheet 502.

### EXAMPLE 2

```
<body>
<div id=“AcmeFlowers_12345” align=center>
<table>
<col span=4>
  <tr id=“row1”><td colspan=4>A1</td></tr>
  <tr id=“row2”><td id=“A2”>A2/td>
          <td>B2/td><td>C2</td><td>D2</td>
  </tr>
  <tr id=“row3”><td>A3</td>
          <td id=“B3” colspan=2 rowspan=2>B3</td>
      <td>D3</td>
  </tr>
  <tr id=“row4”><td>A4</td><td>D4</td></tr>
  <tr id=“row5”><td>A5</td><td>B5</td><td>C5</td><td>D5</td></tr>
  <tr id=“row6”><td>A6</td><td colspan=2>B6/td><td>D6</td></tr>
</table>
</div>
</body>
</html>
```

In the example, the spreadsheet 502 is translated into an HTML table with each cell corresponding to a <td> element corresponding to the cell's position in the columns and rows of the spreadsheet 502. The cell identifiers are placed in the example merely for identification by the reader. They are not required for further processing. Each cell is associated with a corresponding <tr> element corresponding to a row in the spreadsheet 502 associated with the cell. Merged cells can be translated using “rowspan” and “colspan” attributes as illustrated in the example in the <td> elements associated with cell A1, B3, and B6. Note most element attribute information has been removed in order to illustrate the structure of the generated resource in a compact form.

According to an exemplary embodiment, the markup-language-based resource includes first and second markup language representations associated with first and second cells, respectively. For example, the first markup language representation can be a “<td>” element with an ID attribute assigned a value “B3” for first cell B3, and the second markup language representation can be a “<td>” element with an ID attribute assigned a value “A2” associated with the second cell A2.

In one aspect, when the first and second cells are included in a sheet of the electronic media spreadsheet 502, the first and second markup language representations can be included in a markup-language-based page. In another aspect, when the first cell is included in a first sheet of a spreadsheet 502 and the second cell is included in a second sheet of the same or a different spreadsheet 502, the first and second markup language representations can be included in first and second markup-language-based pages, respectively.

In one embodiment, the first cell output can be editable, that is, an input to the first cell can be edited so that the first media stream outputted changes. In this embodiment, the first markup language representation can produce a presentable representation including an input control for modifying the first media stream as an input, and the second markup language representation can include a reference to the first markup language representation. Thus, when the markup-language-based resource is processed by the web browser, a representation of the new first media stream can be produced in accordance with the processing of the first markup language representation, and a presentable representation of a new second media stream can be produced in accordance with the processing of the second markup language representation based on the reference to the first markup language representation.

Returning to FIG. 1, in block 104 directions compatible with the markup-language-based resource representing the expression of the second cell are generated. The generated directions are configured for processing by a web browser with the markup-language-based resource to produce a presentable representation of the second media stream object via the web browser. Accordingly, a system for generating a markup-language-based resource from an electronic media spreadsheet includes means for generating directions compatible with the markup-language-based resource representing the expression of the second cell, where the generated directions are configured for processing by a web browser with the markup-language-based resource to produce a presentable representation of the second media stream object via the web browser. For example, as illustrated in FIG. 2, the export translator component 220 is configured for generating directions compatible with the markup-language-based resource representing the expression of the second cell where the generated directions are configured for processing by a web browser with the markup-language-based resource to produce a presentable representation of the second media stream object via the web browser.

According to one embodiment, the generated directions representing the expression of the second cell can include a reference to a representation of the first media stream so that when the directions are processed by the web browser, the resulting representation of the second media stream is a visual representation to the second media stream output of the second cell. In one embodiment, the export translator component 220 is configured to interoperate with a formula library 215 via the cell evaluator 214 to generate directions representing the expression 506 of the second cell, e.g., cell A2.

The formula library 215 can also be configured to provide access to executable instructions for performing the expression 506. In one embodiment, the formula library 215 can be configured to manage an executable instruction library and/or a markup language library, where the executable instruction and markup language libraries include executable instructions and markup language, respectively, corresponding in result to the functions and/or operators in the expression 506. In one embodiment, the executable instructions can be in the form of programming language instructions, such as JavaScript instructions, machine code instructions, and/or instructions compatible with a virtual machine.

According to one embodiment, the export translator component 220 interoperates with the cell evaluator 214 to invoke the formula library 215 when a cell includes an expression 506. The formula library 215 can, in one embodiment, perform a lookup operation to retrieve directions comprising executable instructions and/or markup language corresponding in result to the expression and compatible with the markup-language-based resource. Alternatively, in another embodiment, the export translator component 220 can be configured to receive source code for the functions and/or operators in the expression 506 and to translate the source code into the directions using the components 232, 234, 236 coupled to the plugin API 230. For example, the functions and/or operators can be translated to Javascript using an XSLT document as input to the XSL engine 236 in FIG. 2A. The XSL engine 236, as is known to those skilled in the art, can be configured to generate any type of document output in addition to generating markup language based output. Alternately, the script generator 234 can perform a similar function using generator technology.

Once the directions are generated, the export translator component 220 can determine, based on the dependency information and in some cases the DOM of the markup-language-based resource, where in the markup-language-based resource to place the directions so that, at least from the perspective of the visual appearance of the markup-language-based resource, the order of cell evaluation is preserved. In addition, the export translator component 220 can accumulate the various sets of instructions associated with the cells of the spreadsheet 502 and can store them in a designated script library for the markup-language-based resource. By creating the script library, the instructions representing the expression in the cell can be referenced in the markup-language-based resource, and need not be explicitly included in the markup-language-based resource.

Example 3 below depicts a version of an exported markup-language-based resource after directions have been generated and inserted in the markup-language-based resource providing content for each of the elements corresponding to the cells in the electronic media spreadsheet 502.

### EXAMPLE 3

```
<html xmlns:time=“urn:schemas-microsoftie-com:time”
        xmlns=“http://www.w3.org/TR/REC-html40”>
<head>
<meta http-equiv=Content-Type content=“text/html;
charset=windows-1252”>
<?import namespace=“time” implementation=“#default#time2”>
<style>.time {behavior: url(#default#time2)}</style>
<style id=“AcmeFlowers_12345_Styles”>
<!--table
-->
</style>
<script src=”./scripts/intro.js” type=“text/javascript”>
Document.getElementById(B3).innerHTML=play(B3.content);
Document.getElementById(A2).innerHtml=play(contrast( size( B3.-
content, 0.25), 0.25));
. . .
</script>
</head>
<body>
<div id=“AcmeFlowers_12345” align=center>
<table>
                <col span=4>
                <tr id=”row1”>
                    <td id=”A1”>Acme Flowers Worldwide</td>
                </tr>
                <tr id=”row2”>
                <td id=”A2”>
                                <!-Generated by Script --->
                            </td>
              <td id=”B2”>B2/td>
              <td id=”C2”>C2</td>
              <td id=”D2”>D2</td>
        </tr>
          <tr id=”row3”>
                <td id=”A3”>A3</td>
                <td id=”B3” colspan=2 rowspan=2>
                                <!-Generated by Script --->
                </td>
                <td id=”D3”>D3</td>
          </tr>
            <tr id=”row4”>
                    <td id=”A4”>A4</td>
                    <td id=”D4”>D4</td>
            </tr>
            <tr id=”row5”>
                    <td id=”A5”>A5</td>
                    <td id=”B5”>B5</td>
                    <td id=”C5”>C5</td>
                    <td id=”D5”>D5</td>
        </tr>
        <tr id=”row6”>
                        <td id=”A6”></td>
                    <td id=”B6” colspan=2>Skip Intro</td>
                    <td id=”C6”></td>
        </tr>
</table>
</div>
</body>
</html>
```

In Example 3, the header portion includes a <script> portion using Javascript. The attribute “src” of the <script> element references a library of Javascript routines that perform functions similar to the functions included in the cells of spreadsheet 502. The script library is provided, in an embodiment, by the formula library 215 interoperating with the export translator component 220 via the cell evaluator 214. In addition the header includes instructions for each cell requiring evaluation in an order consistent with the dependency relationships in the dependency graph. For example, content for the element associated with cell B3 is generated by a “play” Javascript function included in the referenced library of Javascript routines and written to the DOM prior to evaluating the expression for cell A2. In the Example 3, the generated instructions do not behave as a spreadsheet where output from cell B3 would be provided as input to cell A2. The visual aspects are, however, preserved. More advanced script libraries can be developed to support the explicit dependency relationships of the spreadsheet 502.

Example 4 below corresponds to the <body> portion of the markup-language-based resource depicted in Example 2 and illustrates another embodiment for representing the dynamic behavior resulting from the associated expressions 506. In Example 4, the markup-language-based resource includes additional markup based language, which when processed by the web browser emulates the dynamic behavior and appearance of the spreadsheet 502. In one embodiment, Simplified Multimedia Integration Language (SMIL) embedded in HTML can be used to provide for the dynamic behavior of the corresponding spreadsheet cells associated by a reference.

### EXAMPLE 4

```
<body>
<div id=“AcmeFlowers_12345” align=center>
<table>
              <col span=4>
              <tr id=“row1”>
                  <td id=“A1”>Acme Flowers Worldwide</td>
              </tr>
              <tr id=“row2”>
              <td id=“A2”>
                      <time:seq original.begin=“1s” repeatCount=“indefinite”>
                        <time:video
                      src=“http://acmeflowers.com/introC25S1-4.mpg”
                          id=“original”
                      type=“video/mpeg”>
                  </time:seq>
                    </td>
            <td id=“B2”>B2/td>
            <td id=“C2”>C2</td>
            <td id=“D2”>D2</td>
      </tr>
        <tr id=“row3”>
                <td id=“A3”>A3</td>
                <td id=“B3” colspan=2 rowspan=2>
                        <time:seq repeatCount=“indefinite”>
                          <time:video src=“http://acmeflowers.com/intro.mpg”
                          id=“original”
                    type=“video/mpeg”>
                    </time:seq>
            </td>
            <td id=“D3”>D3</td>
      </tr>
        <tr id=“row4”>
              <td id=“A4”>A4</td>
              <td id=“D4”>D4</td>
        </tr>
        <tr id=“row5”>
              <td id=“A5”>A5</td>
              <td id=“B5”>B5</td>
              <td id=“C5”>C5</td>
              <td id=“D5”>D5</td>
        </tr>
        <tr id=“row6”>
                    <td id=“A6”></td>
              <td id=“B6” colspan=2>Skip Intro</td>
              <td id=“C6”></td>
        </tr>
</table>
</div>
</body>
</html>
```

In Example 4, in contrast to scripts, SMIL can be generated that in many cases more closely provides a presentation that resembles the presentation of the spreadsheet 502 when processed in the spreadsheet program 400. For example, the SMIL “begin” attribute can be used to delay the presentation of cell A2's output by one second after the presentation of the output of cell B3. This can be done to account for the fact that the content of cell A2 is evaluated after the content of cell B3 due to cell A2's dependence on the evaluation of cell B3.

Example 5 below also corresponds to the <body> portion of the markup-language-based resource depicted in Example 2. In contrast to Example 4, however, Example 5 includes a reference to a Java bytecode library created by the export translator component 220 for the exported spreadsheet 502 and uses Java bytecode to represent the dynamic behavior resulting from the associated expressions 506. For example, an <applet> element, that references a Java bytecode library that includes instructions representing the expressions 506 of the cells, is inserted for accessing the generated Java bytecode instructions in the library. In addition, a script element is inserted into the <td> element corresponding to the second cell A2 causing a Java evalCellA2( ) method to be evaluated based on the content of the <td> element corresponding to the first cell B3 mirroring the dependency between the cells A2 and B3 in the spreadsheet 502.

### EXAMPLE 5

```
<body>
<div id=“AcmeFlowers_12345” align=center>
<applet code=“SpreadsheetHelper.class”
          name=“sshelp”
          height=1 width=1>
</applet>
<table>
            <col span=4>
            <tr id=”row1”>
              <td id=”A1”>Acme Flowers Worldwide</td>
            </tr>
            <tr id=”row2”>
            <td id=”A2”>
                    <script id=”A2SCR”>
                      Document.getElementById(A2Content).innerHtml
                              = document.sshelp.evalCellA2(“B3”);
                    </script>
                    <div ID=”A2Content”>
                    </div>
              </td>
            <td id=”B2”>B2/td>
            <td id=”C2”>C2</td>
            <td id=”D2”>D2</td>
        </tr>
        <tr id=”row3”>
              <td id=”A3”>A3</td>
              <td id=”B3” colspan=2 rowspan=2>
                        <time:seq repeatCount=“indefinite”>
                          <time:video src=“http://acmeflowers.com/intro.mpg”
                                  id=“original”
                      type=“video/mpeg”>
                      </time:seq>
              </td>
              <td id=”D3”>D3</td>
        </tr>
          <tr id=”row4”>
                <td id=”A4”>A4</td>
                <td id=”D4”>D4</td>
          </tr>
          <tr id=”row5”>
                <td id=”A5”>A5</td>
                <td id=”B5”>B5</td>
                <td id=”C5”>C5</td>
                <td id=”D5”>D5</td>
          </tr>
          <tr id=”row6”>
                        <td id=”A6”></td>
                <td id=”B6” colspan=2>Skip Intro</td>
                <td id=”C6”></td>
          </tr>
</table>
        </div>
        </body>
</html>
```

Most spreadsheets currently do not support media content associated with a cell. In particular, current spreadsheets do not support streaming media content. Further, current methods and systems export static versions of spreadsheets. To reproduce the dynamic behavior of a media spreadsheet, an exported spreadsheet must be imported into a spreadsheet program where typically a re-conversion to a compatible spreadsheet format is performed. According to the embodiments described herein, an electronic media spreadsheet 502 created by a spreadsheet program 400 can be automatically exported to a markup-language-based resource for processing in an application that is not a spreadsheet, e.g., a web browser. When processed by the web browser, the visual presentation of the exported markup-language-based resource is a representation of the electronic media spreadsheet 502. In particular, the presentation of the markup-language-based resource can emulate the dynamic behavior and appearance of the spreadsheet 502.

It should be understood that the various components illustrated in the various block diagrams represent logical components that are configured to perform the functionality described herein and can be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n), a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for generating a markup-language-based resource from an electronic media spreadsheet comprising a plurality of cells, the method comprising:
receiving first and second cell information for first and second cells of an electronic media spreadsheet to produce as first and second cell outputs first and second media streams, respectively, via the electronic media spreadsheet, wherein the second cell information includes an expression dependent on the first cell output for producing the second media stream;
generating a markup-language-based resource having first and second markup language representations of the first and second cells, respectively; and
generating directions compatible with the markup-language-based resource representing the expression of the second cell, wherein the generated directions are configured for processing by a web browser with the markup language-based resource to produce a presentable representation of the second media stream via the web browser.

2. The method of claim 1 wherein receiving the first and second cell information includes at least one of retrieving cell information from a local cell database, receiving cell information via a user input device, receiving cell information via at least one of an event subsystem, a queue, and a pipe, and receiving cell information from a remote source via a network.

3. The method of claim 1 wherein the generated directions include a reference to a representation of the first media stream.

4. The method of claim 1 wherein the generated directions include an executable instruction in the form of at least one of a programming language instruction, a machine code instruction, and an instruction compatible with a virtual machine.

5. The method of claim 1 wherein the expression of the second cell includes at least one of a function and an operator for operating on the first cell output and wherein the method further includes providing a formula library comprising at least one of an instruction library and a markup language library, wherein at least one of the instruction library and the markup language library includes executable instructions and markup language, respectively, corresponding in result to the at least one function and operator of the expression.

6. The method of claim 5 wherein generating directions includes performing a lookup operation to retrieve at least one of instructions and markup language corresponding in result to the expression and compatible with the markup-language-based resource via the formula library.

7. The method of claim 1 wherein generating directions includes receiving source code for the expression and transforming the received source code to executable instructions using a transformation document compatible with the markup-language-based resource.

8. The method of claim 1 wherein generating the markup-language-based resource includes generating a dependency graph based on at least the first cell and the second cell of the electronic media spreadsheet, wherein the dependency graph identifies an order of evaluation between the first cell and the second cell of the electronic spreadsheet.

9. The method of claim 8 wherein generating directions includes placing the generated directions in the markup-language-based resource based on the dependency graph such that the order of cell evaluation is preserved.

10. The method of claim 1 wherein the cell information of the first cell includes a reference for providing the first media stream as an input from a source external to the spreadsheet.

11. The method of claim 1 wherein the first cell and the second cell are included in a sheet of a spreadsheet and the first markup language representation and the second markup language representation are included in a markup-language-based page.

12. The method of claim 1 wherein the first cell is included in a first sheet of a spreadsheet and the second cell is included in a second sheet of a spreadsheet, and the first markup language representation is included in a first markup-language-based page and the second markup language representation is included in a second markup-language-based page.

13. The method of claim 12 wherein the first sheet is included in a first spreadsheet and the second sheet is included in a second spreadsheet.

14. The method of claim 1 wherein generating a markup-language-based resource includes providing a reference in the second markup language representation to the first markup language representation.

15. The method of claim 14 wherein the first cell output is editable and the first markup language representation of the first cell is generated for producing a presentable representation including an input control for modifying the first media stream as an input.

16. The method of claim 15 wherein when the markup-language-based resource is processed by the web browser, a representation of the new first media stream is produced in accordance with the processing of the first markup language representation, and a presentable representation of a new second media stream is produced in accordance with the processing of the second markup language representation based on the reference to the first markup language representation.

17. A system for generating a markup-language-based resource from an electronic media spreadsheet comprising a plurality of cells, the system comprising:
means for receiving first and second cell information for first and second cells of an electronic media spreadsheet to produce as first and second cell outputs first and second media streams, respectively, via the electronic media spreadsheet, wherein the second cell information includes an expression dependent on the first cell output for producing the second media stream;
means for generating a markup-language-based resource having first and second markup language representations of the first and second cells, respectively; and
means for generating directions compatible with the markup-language-based resource representing the expression of the second cell,
wherein the generated directions are configured for processing by a web browser with the markup language-based resource to produce a presentable representation of the second media stream via the web browser.

18. A computer readable medium embodying a computer program, executable by a machine, for generating a markup-language-based resource from an electronic media spreadsheet comprising a plurality of cells, the computer program including executable instructions for:
receiving first and second cell information for first and second cells of an electronic media spreadsheet to produce as first and second cell outputs first and second media streams, respectively, via the electronic media spreadsheet, wherein the second cell information includes an expression dependent on the first cell output for producing the second media stream;
generating a markup-language-based resource having a first and second markup language representations of the first and second cells, respectively; and
generating directions compatible with the markup-language-based resource representing the expression of the second cell, wherein the generated directions are configured for processing by a web browser with the markup language-based resource to produce a presentable representation of the second media stream via the web browser.

19. A system for generating a markup-language-based resource from an electronic media spreadsheet comprising a plurality of cells, the system comprising:
a cell access manager component configured for receiving first and second cell information for first and second cells of an electronic media spreadsheet to produce as first and second cell outputs first and second media streams, respectively, via the electronic media spreadsheet, wherein the second cell information includes an expression dependent on the first cell output for producing the second media stream; and
an export translator component configured for generating a markup-language-based resource having a first and second markup language representations of the first and second cells, respectively, and for generating directions compatible with the markup-language-based resource representing the expression of the second cell,
wherein the generated directions are configured for processing by a web browser with the markup language-based resource to produce a presentable representation of the second media stream via the web browser.

20. The system of claim 19 wherein the generated directions include a reference to a representation of the first media stream.

21. The system of claim 19 wherein the generated directions include an executable instruction in the form of at least one of a programming language instruction, a machine code instruction, and an instruction compatible with a virtual machine.

22. The system of claim 19 wherein the expression of the second cell includes at least one of a function and an operator for operating on the first cell output and wherein the system further includes a formula library comprising at least one of an instruction library and a markup language library, wherein at least one of the instruction library and the markup language library includes executable instructions and markup language, respectively, corresponding in result to the at least one function and operator of the expression, and wherein the export translator component is configured for performing a lookup operation to retrieve at least one of instructions and markup language corresponding in result to the expression and compatible with the markup-language-based resource via the formula library.

23. The system of claim 19 wherein the export translator component is configured for receiving source code for the expression, and transforming the received source code to executable instructions according to a transformation document compatible with the markup-language-based resource.

24. The system of claim 19 wherein the export translator component is configured for generating the markup-language-based resource and a dependency graph based on at least the first cell and the second cell of the electronic media spreadsheet, wherein the dependency graph identifies an order of evaluation between the first cell and the second cell of the electronic spreadsheet, and for placing the generated directions in the markup-language-based resource based on the dependency graph such that the order of cell evaluation is preserved.

25. The system of claim 19 wherein the export translator component is configured for providing a reference in the second markup language representation to the first markup language representation, wherein the first cell output is editable and first markup language representation of the first cell is generated for producing a presentable representation including an input control for specifying a new first media stream as an input, and wherein when the markup-language-based resource is processed by the web browser, a representation of the new first media stream is produced in accordance with the processing of the first markup language representation, and a presentable representation of a new second media stream is produced in accordance with the processing of the second markup language representation based on the reference to the first markup language representation.
